(19) United States
(12) Patent Application Publication
(10) Pub. No.: US 2026/0287349 A1
(43) Pub. Date: Sep. 24, 2026

(54) Rotary Laser

(71) Applicant: Robert Bosch GmbH, Stuttgart (DE)

(72) Inventors: Ben William Carabelli, Leinfelden-Echterdingen (DE); Keith Lam, Warfield (GB); Markus Hahl, Korntal-Muenchingen (DE); Tobias Roehm, Wildberg-Sulz (DE); Tobias Zibold, Stuttgart (DE)

(21) Appl. No.: 19/566,207

(22) Filed: Mar. 13, 2026

(30) Foreign Application Priority Data
Mar. 20, 2025 (DE) 10 2025 110 725.4

(51) Int. Cl. G01C 15/00; G01C 25/00

(52) U.S. Cl. CPC G01C 15/004; G01C 15/008; G01C 25/00

(57) ABSTRACT

A rotary laser includes a housing in which a laser unit is arranged and having a leveling unit with at least one inclination sensor for determining an orientation of the laser unit relative to a reference surface. The at least one inclination sensor has an inclination sensor module housing arranged in the housing of the rotary laser, which has at least one planar support surface on at least one side surface for the planar alignment of the inclination sensor module housing in the housing.

This application claims priority under 35 U.S.C. § 119 to patent application no. DE 10 2025 110 725.4, filed on Mar. 20, 2025 in Germany, the disclosure of which is incorporated herein by reference in its entirety.

### BACKGROUND

The present disclosure relates to a rotary laser with a housing, in which a laser unit is arranged, and with a leveling unit with at least one inclination sensor for determining an orientation of the laser unit relative to a reference surface.

A rotary laser with such a leveling unit is known from the prior art. The laser unit and the leveling unit are arranged in a housing of the rotary laser. The leveling unit comprises at least one inclination sensor for determining a respective orientation of the laser unit relative to a reference surface.

### SUMMARY

The disclosure relates to a rotary laser with a housing, in which a laser unit is arranged, and with a leveling unit with at least one inclination sensor for determining an orientation of the laser unit relative to a reference surface. The at least one inclination sensor has an inclination sensor module housing arranged in the housing of the rotary laser, which has at least one planar support surface on at least one side surface for precisely aligning the inclination sensor module housing in the housing.

The disclosure thus enables the provision of a rotary laser in which the at least one support surface allows the inclination sensor to be precisely aligned in the housing for accurate measurement of the inclination of the laser unit.

Preferably, the housing has a base plate with at least one planar support area, wherein the at least one planar support area is assigned to the at least one planar support surface.

This enables a simple and precise arrangement of the at least one inclination sensor on the base plate in the housing.

Preferably, the at least one planar support surface is divided into at least two spaced-apart sub-surfaces.

This makes it easy and straightforward to achieve a compact arrangement of the at least one flat support surface.

The at least two spaced-apart sub-surfaces are preferably arranged in a common plane, whereby the plane is arranged parallel to the associated side surface of the inclination sensor module housing.

This makes it easy to provide at least one planar support surface.

According to one embodiment, at least one planar support surface has three sub-surfaces arranged in a triangle.

This makes it easy and uncomplicated to provide an alternative planar support surface.

Preferably, the inclination sensor module housing has the at least one support surface on a first side surface, wherein the inclination sensor module housing can be arranged on the first side surface for a first alignment on the base plate by way of the at least one support surface.

This makes the first arrangement of the tilt sensor easy and reliable.

Preferably, the inclination sensor module housing has the at least one support surface on a second side surface, wherein the inclination sensor module housing can be arranged on the second side surface for a second alignment on the base plate by way of the at least one support surface.

This is a simple way of enabling an alternative arrangement of the inclination sensor.

The first side surface is preferably arranged perpendicular to the second side surface.

This makes it easy and uncomplicated to align the inclination sensor module housing in a first direction and a second direction perpendicular to the first direction on the base plate.

Preferably, the base plate has a first section for arranging the inclination sensor module housing in the first orientation and a second section aligned perpendicular to the first section for arranging the inclination sensor module housing in the second orientation.

This allows the first and second alignment to be carried out safely and reliably.

Preferably, a tube level is arranged in an interior receptacle of the inclination sensor module housing, wherein the tube level is fixed in the interior receptacle of the inclination sensor module housing by way of an adhesive bond.

This enables a stable and robust arrangement of the tube level in the inclination sensor module housing.

Preferably, an adhesive for forming the adhesive bond can be introduced into the interior receptacle through a recess from outside the inclination sensor module housing.

This makes it easy to apply the adhesive.

Preferably, the recess is arranged on a side surface of the inclination sensor module housing, which is arranged perpendicular to the at least one support surface.

This makes it easy and uncomplicated to provide a suitable arrangement for the recess.

Furthermore, the present disclosure relates to a method for manufacturing an inclination sensor of a leveling unit for a rotary laser described above, which comprises the following steps:
arranging the tube level within the inclination sensor module housing,
biasing the tube level by way of a spring-loaded element,
compensating for a measurement error by displacing the tube level along its longitudinal extension through at least one lateral recess arranged on the inclination sensor module housing.
applying adhesive through a recess to secure the tube level, and

The present disclosure thus provides a method for manufacturing an inclination sensor in which the adhesive bond enables simple and precise arrangement of the tube level.

Preferably, after pre-securing the tube level, the inclination sensor module housing is closed.

This safely and reliably prevents the unwanted ingress of particles, e.g. dust particles.

Preferably, after the adhesive has been applied, it is cured using UV light, wherein the UV light is irradiated into the inclination sensor module housing through a side UV light introduction area on a fourth side surface of the inclination sensor module housing opposite to the third side surface, or through a UV light introduction area arranged on a top side of the inclination sensor module housing.

This means that the adhesive can be cured quickly and easily.

### BRIEF DESCRIPTION OF THE DRAWINGS

The disclosure is explained in more detail in the following description with reference to the exemplary embodiments shown in the drawings. They show:

FIG. 1 a perspective view of a rotary laser with a laser unit according to the disclosure,

FIG. 2 a perspective view of an inclination sensor of the leveling unit of FIG. 1,

FIG. 3 a perspective view of a partial section through the inclination sensor of FIG. 2 without the shield of FIG. 2, as seen from an bottom side,

FIG. 4 a perspective view of a partial section through the inclination sensor of FIG. 3,

FIG. 5 a perspective view of the inclination sensor of FIG. 2 to FIG. 4 as seen from a rear side,

FIG. 6 a perspective view of the inclination sensor of FIG. 2 to FIG. 5 when as seen from a front side,

FIG. 7 a schematic view of a first arrangement of two inclination sensors of FIG. 2 to FIG. 6,

FIG. 8 a schematic view of a second arrangement of two inclination sensors of FIG. 2 to FIG. 6,

FIG. 9 a perspective view of a base plate associated with the laser unit of FIG. 1,

FIG. 10 a top view of a bottom side of the inclination sensor of FIG. 2 to FIG. 6,

FIG. 11 a cross-sectional view through the inclination sensor of FIG. 2 to FIG. 6,

FIG. 12 an exploded view of a light emitter, a tube level, a light guide and two photodiodes associated with the inclination sensor of FIG. 2 to FIG. 6 and FIG. 11,

FIG. 13 a perspective top view of the light guide of the inclination sensor of FIG. 2 to FIG. 6, FIG. 11 and FIG. 12,

FIG. 14 a schematic view of the inclination sensor of FIG. 2 to FIG. 6, FIG. 11 to FIG. 13 during measurement in a first measurement range,

FIG. 15 a schematic cross-sectional view of the inclination sensor of FIG. 14,

FIG. 16 a schematic cross-sectional view of the inclination sensor of FIG. 14 during measurement in a second measurement range,

FIG. 17 a cross-sectional view of the inclination sensor of FIG. 2 to FIG. 6, FIG. 11 to FIG. 13,

FIG. 18 a schematic view of a control circuit associated with the inclination sensor of FIG. 2 to FIG. 6,

FIG. 19 a graph showing the photocurrents associated with the two photodiodes of the inclination sensor of FIG. 2 to FIG. 6, FIG. 11 to FIG. 13 as a function of the shading of an air bubble associated with the tube level, and

FIG. 20 a graph showing the total current, differential current, and the inclination determined therefrom associated with the control device of FIG. 18.

### DETAILED DESCRIPTION

Elements having the same or a comparable function are provided with the same reference signs in the figures and are described in detail only once.

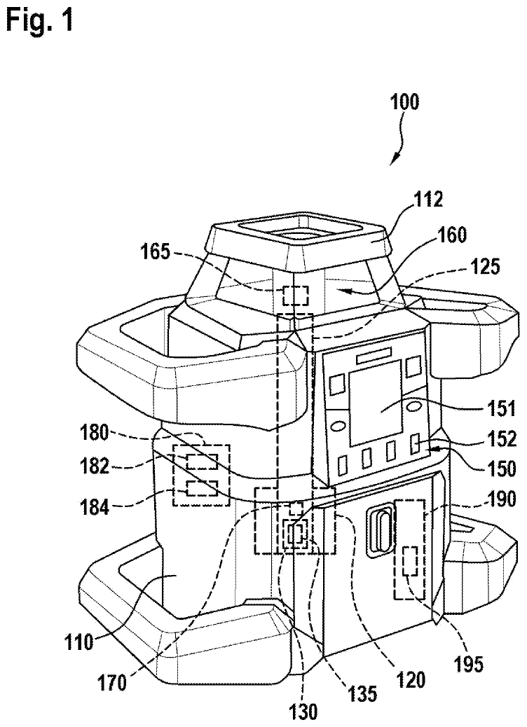

FIG. 1 illustrates an exemplary rotary laser 100 with a housing 110, in which a laser unit 130 with a laser diode 135 for generating a laser beam is arranged. A “rotary laser” may also be understood in the context of the present disclosure to mean a construction laser or a leveling laser. Furthermore, a drive unit 120 for rotationally driving a drive shaft 125 is arranged in the housing 110, for example.

The laser unit 130 is illustratively arranged on the drive shaft 125 such that rotation of the drive shaft 125 rotates the laser beam generated by the laser unit 130 in an associated plane. To this end, the drive shaft 125 is preferably associated with a rotary head 160 with a beam diverter 165. The beam diverter 165 is preferably configured to deflect the laser beam, as a result of which the laser beam projects the associated plane. Alternatively, the beam diverter 165 is configured as a beam splitter, thereby emitting a laser beam perpendicular to the laser plane along an associated laser axis in addition to the projected plane. Depending on the design of the rotary laser 100, the projected plane may be horizontal, vertical, or, e.g., at a defined inclination angle with respect to the earth's surface. The drive unit 120 is preferably configured as an electric motor.

Moreover, an electronic unit 190 with a control and monitoring device 195 is preferably arranged in the housing 110. The control and monitoring device 195 is preferably configured to control the laser output of the laser unit 130 depending on a mode of operation. A rotational speed of the drive shaft 125 of the drive unit 120 is thus controlled or regulated. Preferably, a determination unit 170 is associated with the drive shaft 125 for this purpose.

According to one embodiment, the housing 110 is associated with a protective cage 112 associated with the rotary head 160 to protect against something coming into contact with the rotary head 160.

The electronic unit 190 is preferably associated with a operating unit 150 with a display 151 and an input unit 152. The operating unit 150 is preferably connected to the electronic unit 190, in particular to the control and monitoring device 195, for control or regulation. The input unit 152 preferably comprises at least one keypad. In a minimized embodiment, the input unit 152 comprises only an on/off switch, in particular an on/off button. Alternatively, it is also conceivable that the input unit 152 comprises a control dial, a touch screen, a slider, a remote control, or the like. For example, via the input unit 152, a user may enter a rotational speed for the drive shaft 125. Alternatively, the rotational speed of the laser unit 130 is automatically controllable in one mode of operation.

Preferably, the rotary laser 100 comprises a leveling unit 180. The leveling unit 180 preferably comprises at least one inclination sensor 184 configured to determine an inclination of the rotary head 160, in particular of the beam diverter 165, and/or of the laser unit 130, relative to a predetermined, preferably horizontal direction or to a vertical direction. Moreover, the leveling unit 180 preferably comprises at least one inclination adjustment motor 182 configured to align the rotary head 160, in particular the beam diverter 165, and/or the laser unit 130, depending on a position determined by the at least one inclination sensor 184, preferably a inclination of the laser unit 130 and/or the rotary head 160, preferably in the vertical direction.

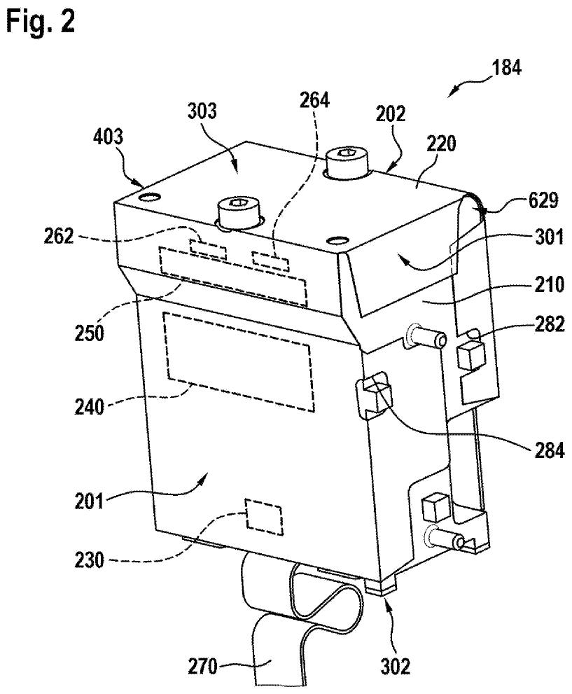

FIG. 2 shows an exemplary inclination sensor 184 associated with the leveling unit 180 of FIG. 1. The inclination sensor 184 comprises an inclination sensor module housing 210 arranged within the housing 110 of the rotary laser 100 of FIG. 1. The inclination sensor module housing 210 preferably has an at least approximately cuboid base body with a first, illustratively right side surface 301, a second, illustratively lower side surface 302 arranged perpendicular to the first side surface 301, and a third, illustrative rear side surface 202 and an opposite fourth side surface 201. Furthermore, a fifth side surface 403, shown as the left side in the illustration, is provided opposite the first side surface 301, and a top side 303 is opposite the second side surface 302.

An infrared shield 220 is preferably arranged on an outer circumference 629 of the inclination sensor module housing 210. Preferably, the infrared shield 220 is arranged at least partially on the inclination sensor module housing 210. Preferably, the infrared shield 220 is attached to the inclination sensor module housing 210 by way of an adhesive bond. Preferably, a double-sided adhesive tape is provided for forming the adhesive bond between the infrared shield 220 and the inclination sensor module housing 210. The infrared shield 220 is impermeable to wavelengths in the infrared frequency band such that wavelengths in the infrared frequency band cannot leave the inclination sensor module housing 210. For example, the infrared shield 220 may be formed as an aluminum-laminated adhesive film. Alternatively, the infrared shield 220 is formed as a stamped and bent part. The infrared shield 220 preferably partially surrounds the inclination sensor module housing 210. In the illustration, the infrared shield 220 is bent around the inclination sensor module housing 210. Preferably, the infrared shield 220 is arranged at least on the third and/or fourth side surfaces 202, 201.

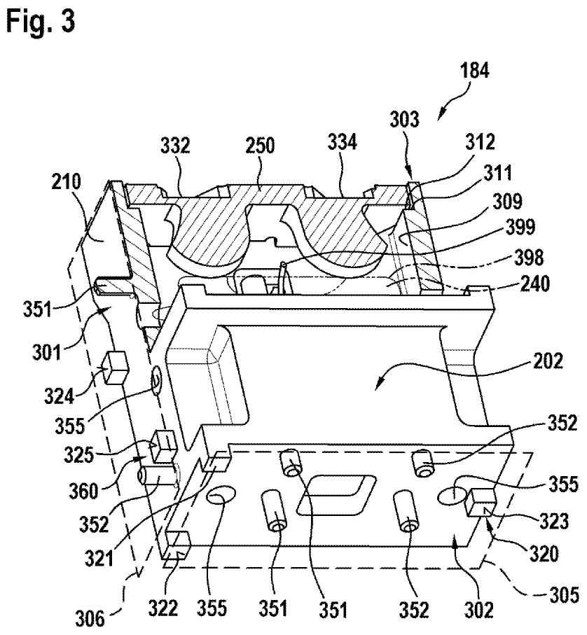

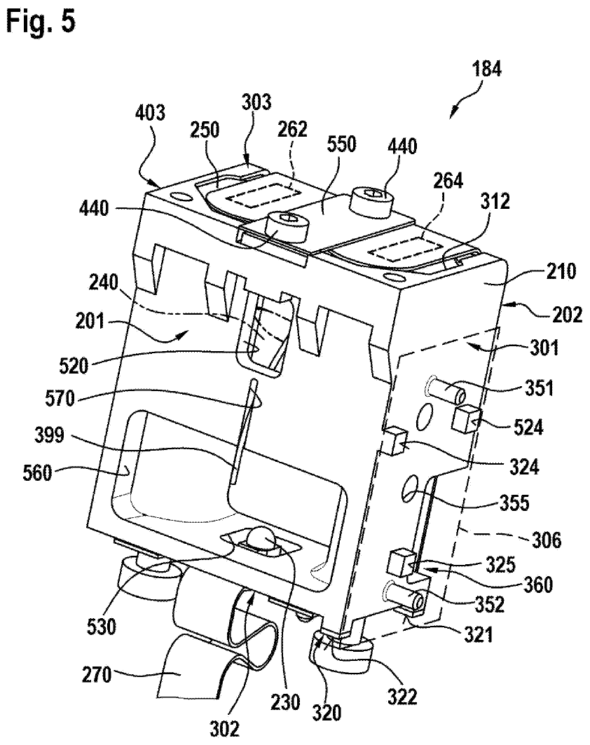

By way of example, the infrared shield 220 comprises two recesses 282, 284. The recesses 282, 284 are preferably configured to allow parts associated with the inclination sensor module housing 210 to pass through. In the illustration, sub-surfaces (324 in FIG. 3 and 524 in FIG. 5) of the inclination sensor module housing 210 pass through the recesses 282, 284 of the infrared shield 220. More particularly, the recesses 282, 284 are preferably associated with at least one planar support surface (320, 360 in FIG. 3) associated with the inclination sensor module housing 210.

In the inclination sensor module housing 210, a tube level 240 and an infrared emitter 230 are preferably arranged to determine an orientation of the laser unit 130 of FIG. 1. Preferably, a light guide 250 is arranged in the inclination sensor module housing 210 spaced apart from the tube level 240. Moreover, the inclination sensor 184 preferably comprises at least one photodiode 262, 264 in its inclination sensor module housing 210. In the illustration, two photodiodes 262, 264 are provided.

The light guide 250 is preferably comprised of glass or transparent plastic. According to one embodiment, the light guide 250 is made of glass or transparent plastic. Preferably, the light guide 250 is secured to the inclination sensor module housing 210. The light guide 250 is thereby secured to the inclination sensor module housing 210, e.g., by way of a screw connection. Alternatively or optionally, the light guide 250 is secured to the inclination sensor module housing 210, e.g., by way of an adhesive bond. According to one embodiment, the light guide 250 is formed integrally with the inclination sensor module housing 210.

Furthermore, the inclination sensor 184 preferably comprises a flexible circuit board 270. Preferably, the infrared emitter 230 and the at least one photodiode 262, 264 are arranged on the flexible circuit board 270. The flexible circuit board 270 is preferably arranged on the outer circumference 629 of the inclination sensor module housing 210. The flexible circuit board 270 preferably at least partially surrounds the inclination sensor module housing 210. The flexible circuit board 270 is arranged, for example, partially between the inclination sensor module housing 210 and the infrared shield 220.

FIG. 3 shows the inclination sensor 184 with the inclination sensor module housing 210 of FIG. 2 without the infrared shield 220 of FIG. 2. The inclination sensor module housing 210 preferably comprises at least one planar support surface 320, 360 on at least one side surface 301, 302 for planar alignment of the inclination sensor module housing 210 in the housing 110. In this way, a precise arrangement of the inclination sensor 184 relative to the laser unit 130 can be achieved, thereby allowing for an exact and precise measurement of an inclination of the laser unit. In the context of the disclosure, a “planar support surface” is understood to mean a planar surface that was preferably machined using a precision tool, e.g., a face-milling cutter or a surface grinding tool.

Preferably, the at least one planar support surface 320, 360 is divided into at least two spaced-apart sub-surfaces 321, 322, 323, 324, 325, (524 in FIG. 5). Preferably the at least two spaced-apart sub-surfaces 321, 322, 323, 324, 325, (524 in FIG. 5) are arranged in at least one common plane 305, 306. The plane 305, 306 is arranged parallel to the associated side surface 301, 302 of the inclination sensor module housing 210 in the illustration. In particular, the plane 305 is arranged perpendicularly to the plane 306.

In the illustration, the sub-surfaces 321, 322, 323 are associated with the plane 305 that is arranged at least substantially in parallel to the second side surface 302 of the inclination sensor module housing 210, which second side surface is shown as the bottom side in the illustration. The second side surface 302 is arranged in parallel to the light guide 250, by way of example. In the illustration, the sub-surfaces 324, 325 are associated with the plane 306 arranged at least substantially in parallel to the first side surface 301 of the inclination sensor module housing 210, which first side surface is shown as the left side in the illustration The second side surface 302 is preferably arranged at least substantially perpendicularly to the first side surface 301.

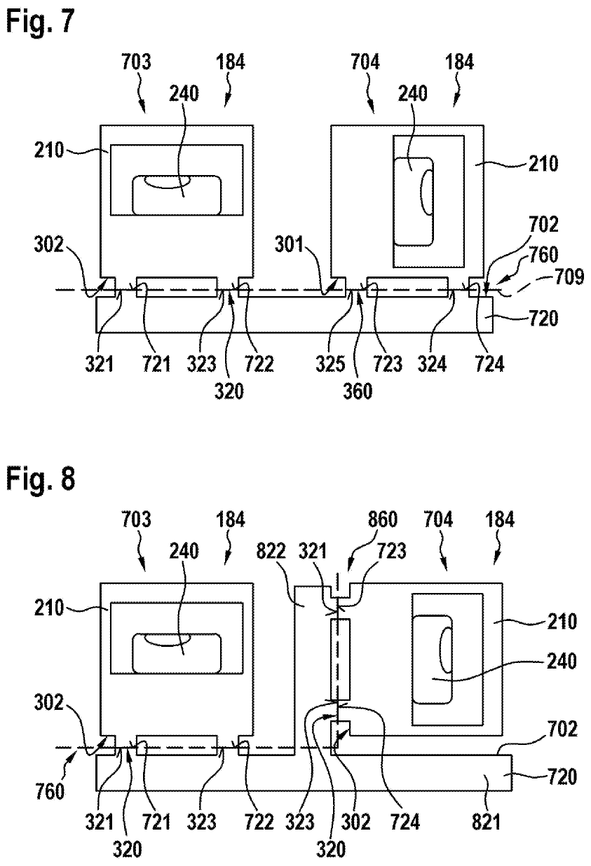

Preferably, at least one centering pin 351, 352 is associated with the side surface 301 and/or the side surface 302. In the illustration, two centering pins 351 and two centering pins 352 are each associated with the side surface 302, and one centering pin 351 and 352 are each associated with the side surface 301. The centering pins 351, 352 are configured to clearly and repeatably position the inclination sensor 184 on a base plate (720 in FIG. 7 to FIG. 9). Moreover, preferably, the side surface 301 and/or the side surface 302 comprises at least one recess 355 for securing it in the housing 110 of FIG. 1.

Preferably, the tube level 240 is arranged in an interior receptacle 309 of the inclination sensor module housing 210. To position the tube level 240 in the interior receptacle 309 of the inclination sensor module housing 210, a spring-loaded element 399 is shown in the illustration. The spring-loaded element 399 thereby preferably presses the tube level 240 into a predetermined position on its outer circumference 398. By way of example, the spring-loaded element 399 is configured as a wire spring or leaf spring.

Preferably, the tube level 240 is secured in the interior receptacle 309 of the inclination sensor module housing 210 by an adhesive bond. Preferably, an adhesive forming the adhesive bond is curable by way of UV light. According to one embodiment, the inclination sensor module housing 210 comprises a UV light introduction area 312 (520 in FIG. 5) on the side surface 201 or on the top side 303 for curing the adhesive that secures the tube level 240 in the inclination sensor module housing 210. In this case, the adhesive is cured, e.g., by way of a UV lamp.

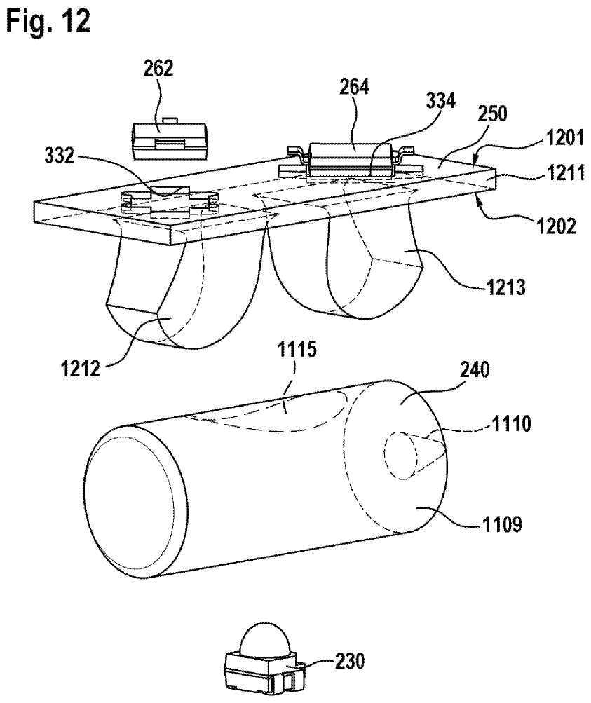

Moreover, the light guide 250 is shown in the illustration to be received in a receptacle 311 associated with the interior receptacle 309 and facing the top side 303 of the inclination sensor module housing 210. Preferably, the light guide 250 comprises at least one receptacle 332, 334 for accommodating at least one photodiode 262, 264 on its side (1201 in FIG. 12) facing away from the tube level 240, or on the side facing the top side 303. In the illustration, the receptacle 332 is provided for accommodating the photodiode 262 and the receptacle 334 for accommodating the photodiode 264. Alternatively, multiple photodiodes 262, 264 may also be arranged in a common receptacle 332, 334.

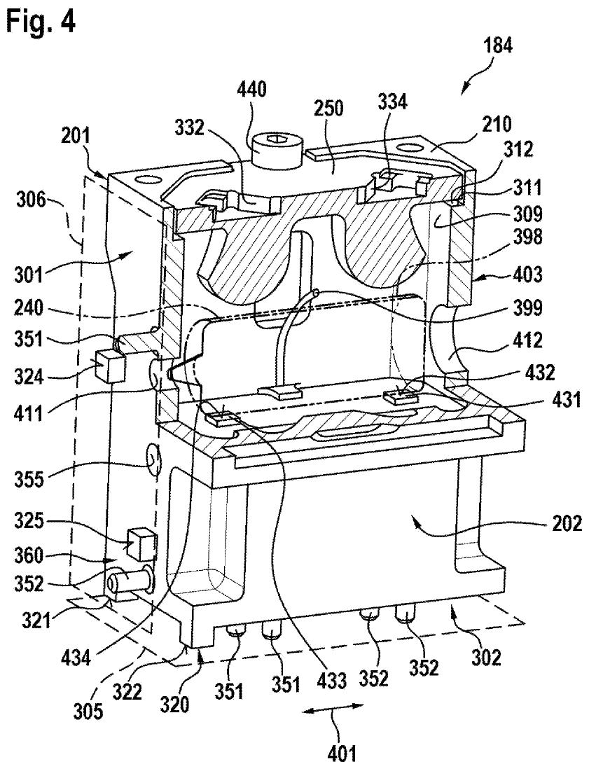

FIG. 4 shows the inclination sensor 184 of FIG. 1 to FIG. 3. FIG. 4 illustrates the arrangement of the light guide 250 in the receptacle 311 of the inclination sensor module housing 210. In the illustration, the light guide 250 is secured to the inclination sensor module housing 210 by way of at least one screw 440. Alternatively, the light guide 250 is secured to the inclination sensor module housing 210 by way of an adhesive bond. However, the light guide 250 can also be fixed in the inclination sensor module housing 210 simply by being arranged in the receptacle 311 of the inclination sensor module housing 210, since the receptacle 311 tapers toward the tube level 240 or, illustratively, downwards into the interior receptacle 309 of the inclination sensor module housing 210.

Furthermore, FIG. 4 shows the arrangement of the tube level 240 in the interior receptacle 309 of the inclination sensor module housing 210. Preferably, the tube level 240 is supported on at least one, illustratively on two support elements 431, 433 in the interior receptacle 309. The at least one support element 431, 433 preferably comprises at least one planar support surface 432, 434. In the illustration, the support element 431 comprises the planar support surface 432 and the support element 433 comprises the planar support surface 434. The tube level 240 preferably rests, with its outer circumference 398, on the planar support surfaces 432, 434. Preferably, the planar support surfaces 432, 434 are arranged in parallel to the support surface 320 of the side surface 302, shown as the bottom side in the illustration. According to one embodiment, the planar support surfaces 432, 434 are arranged perpendicularly to the support surface 360 of the side surface 301, shown as the left side in the illustration.

Moreover, the inclination sensor module housing 210 preferably comprises at least one recess 411, 412 on the side surface 301, shown as the left side in the illustration, and on a fifth side surface 403 for displacing the tube level 240 along its longitudinal extension 401. In the illustration, two recesses 411, 412 are provided, wherein the recess 411 is associated with the side surface 301 and the recess 412 is associated with the side surface 403. The fifth side surface 403 is arranged to the right in the illustration by way of example, opposite the side surface 301 in FIG. 4. The recess 411 is associated with the side surface 301, shown on the left in the illustration, and the recess 412 is associated with the illustrative side surface 403, shown on the right in the illustration. By way of example, the recess 412, shown on the right in the illustration, has a larger diameter than the recess 411, shown on the left in the illustration.

FIG. 5 shows the inclination sensor 184 of FIG. 1 to FIG. 4 and illustrates the securing of the light guide 250 to the top side 303 of the inclination sensor module housing 210 by way of preferably two screws 440. For certain and reliable securing, an optional pressure plate 550 is provided, which secures the light guide 250 to the top side 303 by way of the screws 440. Alternatively, or optionally, the light guide 250 is secured to the top side 303 of the inclination sensor module housing 210 by way of an adhesive bond. Preferably, an adhesive for forming the adhesive bond between the light guide 250 and the top side 303 of the inclination sensor module housing 210 is a UV-curing adhesive.

Furthermore, FIG. 5 shows the side surface 201 of the inclination sensor module housing 210, which preferably comprises a recess 560. The recess 560 is formed in the area proximate the side surface 302, shown as the bottom side in the illustration. Preferably, the side surface 302 comprises a recess 530, in which the infrared emitter 230 is arranged. Moreover, the side surface 201 has recess 570, shown as a slit in the illustration, that is configured to arrange the flexible element 399 partially in the interior receptacle 309 in FIG. 3 and FIG. 4 of the inclination sensor module housing 210.

According to one embodiment, the inclination sensor module housing 210 comprises a UV light introduction area 520 on the side surface 201 for curing, by way of a UV lamp, an adhesive that secures the tube level 240 in the inclination sensor module housing 210. The UV light introduction area 520 is arranged on an area of the side surface 201 facing the light guide 250, an upper area in the illustration. The side surface 201 is closed off by the infrared shield 220 of FIG. 2 in the mounted state of the inclination sensor 184, as shown in FIG. 2.

FIG. 5 further illustrates the planar support surface 360 associated with the side surface 301. The planar support surface 360 has sub-surfaces 324, 325, 524, as described above. The sub-surfaces 324, 325, 524 are associated with the plane 306.

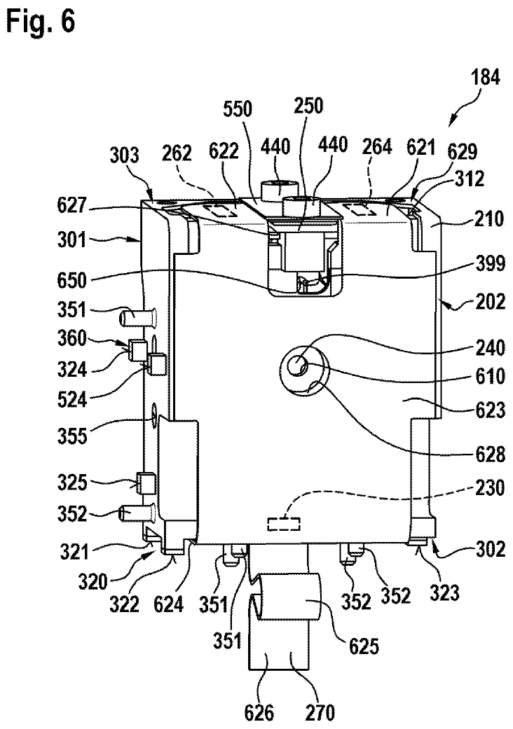

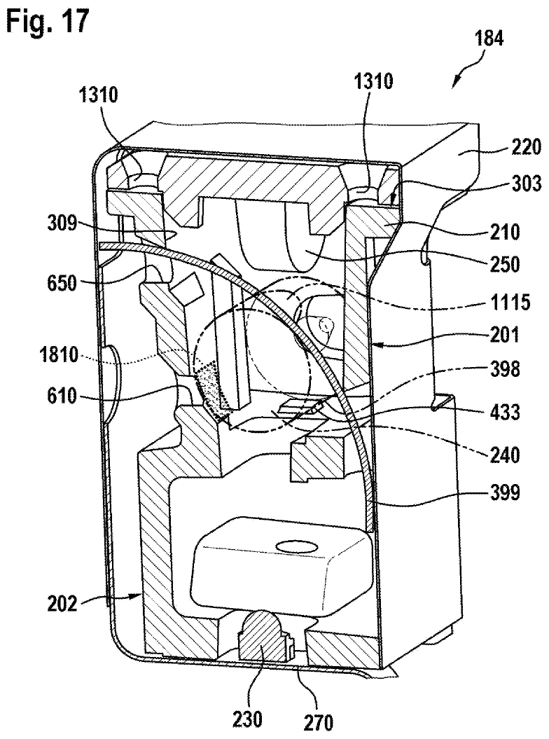

FIG. 6 shows the inclination sensor 184 of FIG. 1 to FIG. 5 as viewed from the side surface 202. To secure the tube level 240 in the interior receptacle 309 of FIG. 3 and FIG. 4 of the inclination sensor module housing 210 by way of an adhesive bond, the inclination sensor module housing 210 preferably comprises a recess 610, or an adhesive application recess 610, through which adhesive (1810 in FIG. 17) can be delivered to the interior receptacle 309 from outside of the inclination sensor module housing 210. Preferably, the recess 610 is arranged on the side surface 202. Furthermore, by way of example, the side surface 202 comprises a recess 650, in which the spring-loaded element 399 is arranged. In the illustration, the recess 650 is arranged above the recess 610.

Moreover, FIG. 6 illustrates the flexible circuit board 270 arranged on the outer circumference 629 of the inclination sensor module housing 210 and at least partially surrounding the inclination sensor module housing 210. In the illustration, the flexible circuit board 270 comprises a first circuit board section 621, 622, on which the at least one photodiode 262, 264 is arranged. By way of example, two first circuit board sections 621, 622 are configured, wherein each first circuit board section 621, 622 receives a photodiode 262, 264. In the illustration, the right first circuit board section 621 is associated with the photodiode 264 and the left first circuit board section 622 is associated with the photodiode 262. A recess 627 is preferably formed between the two first circuit board sections 621, 622. The recess 627 is configured to compensate for an existing positioning tolerance of the two photodiodes 262, 264 on the flexible circuit board 270 such that the photodiodes 262, 264 can be precisely placed in the recesses 332, 334 of FIG. 3 and FIG. 4, provided for this purpose, in the light guide 250. In the illustration and by way of example, the optional pressure plate 550 of the light guide 250 is arranged in the recess 627.

Furthermore, the flexible circuit board 270 preferably comprises a second circuit board section 624, on which the infrared emitter 230 is arranged. The first and second circuit board sections 621, 622, 624 are preferably connected to each other via a connecting section 623. The connecting section 623 is arranged on the side surface 202 in the illustration. The connecting section 623 preferably comprises a recess 628 associated with the recess 610 of the inclination sensor module housing 210.

Preferably, the at least one first circuit board section 621, 622, the two first circuit board sections 621, 622 shown in the illustration, is arranged and secured on the top side 303 of the inclination sensor module housing 210. The first circuit board sections 621, 622 are preferably secured to the top side 303 by way of an adhesive bond. Preferably, the first circuit board sections 621, 622 are secured to the light guide 250. Preferably, the first circuit board sections 621, 622 are secured to the light guide 250 by way of an optically transparent adhesive bond. Thus the optically transparent adhesive bond is formed between the at least one photodiode 262, 264 and the light guide 250, in particular the at least one receptacle 332, 334 of FIG. 3 and FIG. 4 of the light guide 250. By way of the optically transparent adhesive bond, an air gap formed between the light guide 250 and the photodiodes 262, 264 can be eliminated and thus a corresponding light coupling can be optimized. Preferably, the second circuit board section 624 is on the side surface 302, shown as the bottom side in the illustration, of the inclination sensor module housing 210. Preferably, the second circuit board section 624 comprises the infrared emitter 230. Preferably, the second circuit board section 624 is secured to the side surface 302, shown as the bottom side in the illustration, by way of an adhesive bond.

Preferably, double-sided adhesive tape is arranged between the flexible circuit board 270 and the inclination sensor module housing 210 to form the adhesive bond described above. Moreover, the flexible circuit board 270 comprises a contacting section 626. The contacting section 626 is preferably connected to the second printed circuit board section 624 via a flexible connecting section 625.

It is noted that the tube level 240 is preferably secured in the inclination sensor module housing 210 by way of a UV-cured adhesive, the at least one first circuit board section 621, 622 is preferably secured in the light guide 250 by way of a UV-cured adhesive, and the flexible circuit board 270 is preferably secured in the inclination sensor module housing 210 by way of double-sided adhesive tape. Alternatively, the at least one first circuit board section 621, 622 may be attached to the light guide 250 with a non-UV-cured adhesive.

FIG. 7 depicts a base plate 720 associated with the housing 110 of FIG. 1, on which the at least one inclination sensor 184 of FIG. 1 to FIG. 6 can be arranged. The base plate 720 is movably supported in the housing 110 of FIG. 1 along with the laser unit 130 of FIG. 1. In the illustration, two inclination sensors 184 are arranged on the base plate 720. For this purpose, the base plate 720 preferably comprises at least one planar support area 760 on a side 702 facing the inclination sensors 184. Preferably, the at least one planar support area 760 is associated with the at least one planar support surface 320, 360 of the inclination sensor module housing 210.

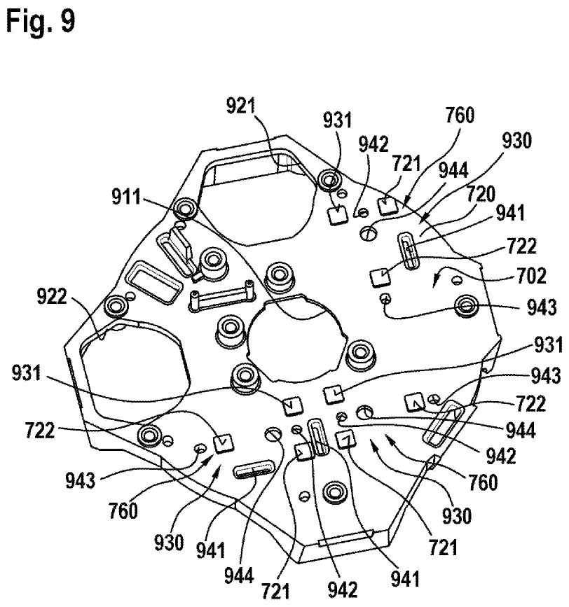

The planar support area 760 is preferably divided into at least two spaced-apart sub-areas 721, 722, 723, 724. The at least two spaced apart sub-areas 721, 722, 723, 724 are preferably arranged in a common plane 709. The plane 709 is arranged in parallel to the side 702 of the base plate 720 in the illustration. Preferably, the planar support area 760 comprises three spaced-apart sub-areas 721, 722; (931 in FIG. 9). The three planar sub-areas 721, 722; (931 in FIG. 9) of a planar support area 760 are preferably arranged in a triangle analogous to the three sub-surfaces 321, 322, 323, 324, 325; 524 of a planar support surface 320, 360.

The inclination sensor 184, shown on the left in the illustration, with its planar support surface 320 of the inclination sensor module housing 210 arranged on the side surface 302, is arranged, by way of example, in a first orientation 703, on the planar support area 760 of the base plate 720. Preferably, the first orientation 703 is a horizontal orientation of the inclination sensor 184 on the base plate 720. The sub-surface 321 of the inclination sensor module housing 210 abuts the sub-area 721 of the base plate 720 and the sub-surface 323 of the inclination sensor module housing 210 abuts the sub-area 722 of the base plate 720.

The inclination sensor 184, shown on the right in the illustration, with its planar support surface 360 of the inclination sensor module housing 210 arranged on the side surface 301, is preferably arranged, in a second orientation 704, on the planar support area 760 of the base plate 720. Preferably, the second orientation 704 is a vertical orientation of the inclination sensor 184 on the base plate 720. The sub-surface 325 of the inclination sensor module housing 210 is illustratively abutting the sub-area 723 of the base plate 720, and the sub-surface 324 of the inclination sensor module housing 210 is illustratively abutting the sub-area 724 of the base plate 720.

FIG. 8 illustrates the base plate 720 with two inclination sensors 184 of FIG. 7, wherein the base plate 720 illustratively comprises a first section 821 and a second section 822 aligned perpendicularly to the first section 821. Preferably, the first section 821 is configured to arrange the inclination sensor 184 or the inclination sensor module housing 210 in the first orientation 703, and the second section 822 is configured to arrange the inclination sensor 184 or the inclination sensor module housing 210 in the second orientation 704.

The inclination sensor 184, shown on the left in the illustration, with its planar support surface 320 of the inclination sensor module housing 210 arranged on the side surface 302, is preferably arranged, in the first orientation 703, on the planar support area 760 of the first section 821 of the base plate 720. The sub-surface 321 of the inclination sensor module housing 210 is illustratively abutting the sub-area 721 of the first section 821 of the base plate 720, and the sub-surface 323 of the inclination sensor module housing 210 is illustratively abutting the sub-area 722 of the first section 821 of the base plate 720.

The inclination sensor 184, shown on the right in the illustration, with its planar support surface 320 of the inclination sensor module housing 210 arranged on the side surface 302, is preferably arranged, in the second orientation 704, on a planar support area 860 of the second section 822 of the base plate 720. The sub-surface 321 of the inclination sensor module housing 210 is illustratively abutting the sub-area 723 of the second section 822 of the base plate 720, and the sub-surface 323 of the inclination sensor module housing 210 is illustratively abutting the sub-area 724 of the second section 822 of the base plate 720.

FIG. 9 shows the base plate 720 according to an alternative arrangement, in which three inclination sensors 184 are preferably arrangeable on the side 702 of the base plate 720. The base plate 720 illustratively comprises three mounting locations 930 for arranging an inclination sensor 184. Each mounting location 930 preferably comprises a planar support area 760. Preferably, the three mounting locations 930, or the three planar support areas 760, are arranged in a common plane. Alternatively, each planar support area 760 has an associated plane.

Preferably, each planar support area 760 comprises three sub-areas 721, 722, 931, preferably arranged in a triangle, as described above. Preferably, a recess 944 is arranged at the focal point of the triangle for securing the inclination sensor 184 and/or the inclination sensor module housing 210. Preferably, the inclination sensor module housing 210 is secured to the base plate 720 by way of a screw connection. Furthermore, each mounting location 930 is preferably associated with two receptacles 942, 943 for accommodating the centering pins 351, 352 of the inclination sensor module housing 210 of FIG. 3. In addition, each mounting location 930 is illustratively associated with a slot-shaped recess 941 for passing through the printed circuit board 270, in particular the flexible connection section 625 of FIG. 6 and/or the contacting section 626 of FIG. 6 of the inclination sensor 184 of FIGS. 1 to 8.

Furthermore, preferably, the base plate 720 comprises a recess 911 for partially accommodating the laser unit 130 of FIG. 1. At least the drive shaft 125 of the drive unit 120 of the laser unit 130 of FIG. 1 is partially arranged in the recess 911. Preferably, the recess 911 is configured as a central recess of the base plate 720. Moreover, the base plate 720 preferably comprises two receptacles 921, 922, each configured to receive an inclination setting motor 182 of the leveling unit 180 of FIG. 1.

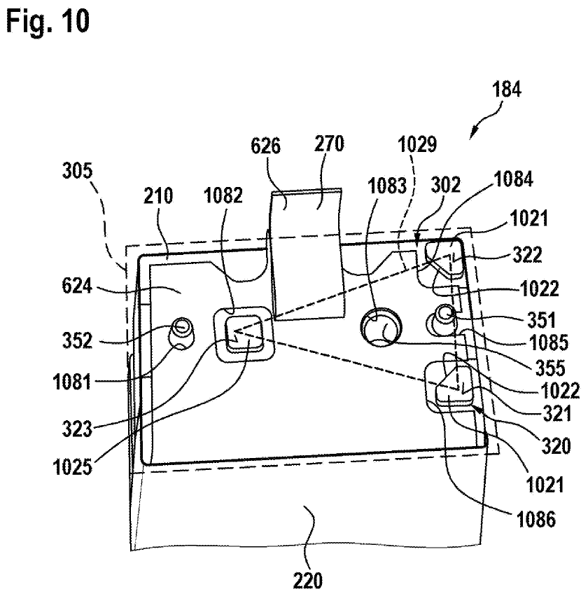

FIG. 10 shows the inclination sensor 184 of FIG. 1 to FIG. 8 and illustrates the side surface 302 with the planar support surface 320. According to FIG. 10, preferably the three sub-surfaces 321, 322, 323 are arranged in a triangle 1029. Preferably, the sub-surface 323, shown on the left in the illustration, has a rectangular base surface 1025. Preferably, the sub-surfaces 321, 322 also have a rectangular base surface 1021. According to one embodiment, the base surfaces 1021 of the sub-surfaces 321, 322 each have a flat area 1022. The flat area 1022 is preferably arranged facing a focal point of the triangle 1029.

Furthermore, FIG. 10 illustrates the second circuit board section 624 of the flexible circuit board 270. Preferably, the second circuit board section 624 comprises a recess 1083 associated with the recess 355. Thus, a screw connection may be formed between the recess 355 of the inclination sensor module housing 210 and the recess 944 of the base plate 720 to secure the inclination sensor 184 to the base plate 720. Preferably, the second circuit board section 624 comprises recesses 1082, 1084, 1086 associated with the sub-surfaces 321, 322, 323, wherein the recess 1082 is associated with the sub-surface 323, the recess 1084 is associated with the sub-surface 322, and the recess 1086 is associated with the sub-surface 321. Moreover, the second circuit board section 624 illustratively comprises recesses 1081, 1085 associated with the centering pins 351, 352 of the inclination sensor module housing 210, particularly the planar support surface 320 of the side surface 302. The recess 1081 is preferably associated with the centering pin 352, and the recess 1085 is associated with the centering pin 351.

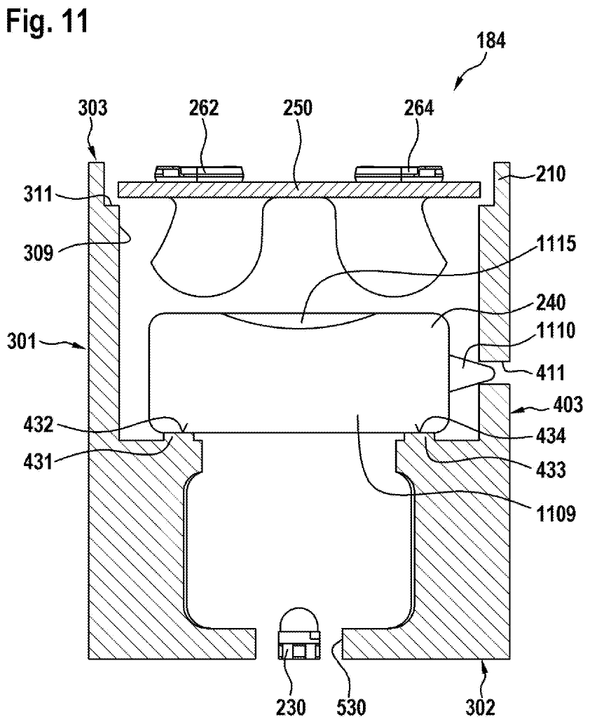

FIG. 11 shows the inclination sensor 184 of FIG. 2 to FIG. 6 with the infrared emitter 230 arranged in the interior receptacle 309 of the inclination sensor module housing 210, the tube level 240, the light guide 250 and preferably two photodiodes 262, 264. The tube level 240 preferably comprises a cylindrical base body 1109 with a preferably tapered tip 1110. The tapered tip 1110 is preferably arranged partially in the recess 411 of the side surface 403, shown on the right in the illustration, of the inclination sensor module housing 210. In addition, in the illustration, an air bubble 1115 is arranged in the base body 1109 of the tube level 240. The air bubble 1115 moves according to a present inclination of the tube level 240.

FIG. 12 shows the infrared emitter 230 associated with the inclination sensor of FIG. 2 to FIG. 6 and FIG. 11, the tube level 240, the light guide 250, and preferably the two photodiodes 262, 264. The light guide 250 comprises an base body 1211, shown as rectangular in the illustration. Preferably, at least one receptacle 332, 334 for accommodating at least one photodiode 262, 264 is arranged on the side 1201 of the light guide 250 facing away from the tube level 240. In the illustration, two receptacles 332, 334 are formed on the side 1201, shown as the top side in the illustration, of the base body 1211 of the light guide 250. Furthermore, preferably, the light guide 250, at its side 1202 facing the tube level 240, comprises two extensions 1212, 1213 associated with the photodiodes 262, 264. In the illustration, the extension 1212 is associated with the photodiode 262 that may be arranged in the receptacle 332, and the extension 1213 is associated with the photodiode 264 that may be arranged in the receptacle 334.

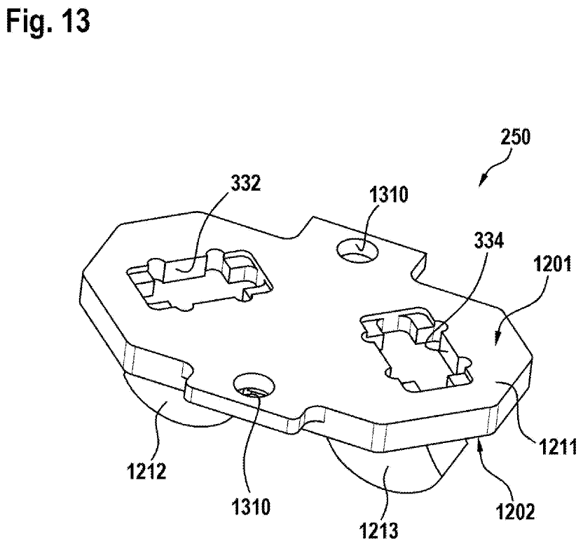

FIG. 13 shows the light guide 250 of FIG. 12 and illustrates the base body 1211 of the light guide 250 with the two receptacles 332, 334. Furthermore, the base body 1211 preferably comprises at least one, whereby two are shown in the illustration, recesses 1310 for being secured to the inclination sensor module housing 210 by way of the screw 440 of FIG. 4 or for applying adhesive for being secured by way of an adhesive bond.

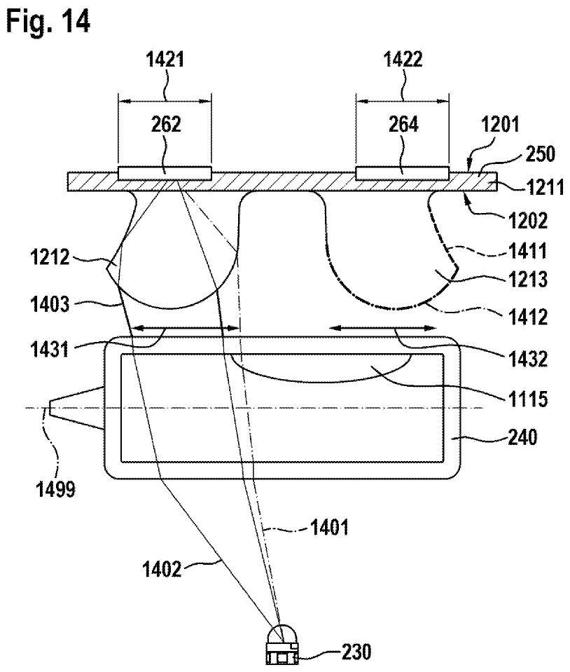

FIG. 14 shows the infrared emitter 230 associated with the inclination sensor of FIG. 2 to FIG. 6 and FIG. 11 and FIG. 12, the tube level 240, and the light guide 250 with preferably two photodiodes 262, 264. Preferably, in the absence of the associated air bubble 1115 in an associated measuring range, the tube level 240 is designed as a converging lens along a direction that is substantially perpendicular to a spirit level axis 1499 associated with the rotary level 240, due to a comparably large inclination of the inclination sensor module housing 210. The level axis 1499 is preferably an axis of symmetry of the tube level 240. A path 1401 illustratively represents a boundary, up to which the location of the air bubble 1115 has an impact on a photocurrent associated with one of the photodiodes 262. If the air bubble 1115 is located further to the right, as shown in the illustration, the photodiode 262 is saturated.

Preferably, the tube level 240 is configured to transmit a light beam 1402 generated by the infrared emitter 230. The light guide 250 is preferably configured to focus the transmitted light beam 1403 and direct it onto the photodiodes 262, 264. Here, the light guide 250 is preferably designed to image at least one level section 1431, 1432, which is not, partially or completely shaded depending on the deflection of the associated air bubble 1115 within a measuring range assigned to the tube level 240, onto a photosensitive area 1421, 1422 of the at least one photodiode 262, 264. In this respect, a monotonic dependence, of a photocurrent of the photodiodes 262, 264, on the position of the air bubble 1115 without saturation in this area is preferably achieved.

Furthermore, in the presence of the associated air bubble 1115, the tube level 240 preferably scatters the light beam 1402 generated by the infrared emitter 230. Preferably, the extensions 1212, 1213 of the light guide 250 each comprise a convex section 1412 and a flat area 1411. The convex sections 1412 are preferably arranged facing the tube level 240, and the flat areas 1411 each form a side facing outward. Preferably, the convex sections 1412 form cylindrical, focusing interfaces of the extensions 1212, 1213. The flat areas 1411 preferably form totally internally reflective interfaces of the extensions 1212, 1213. The reflective interfaces allow for a compact design with punctiform illumination by the infrared emitter 230.

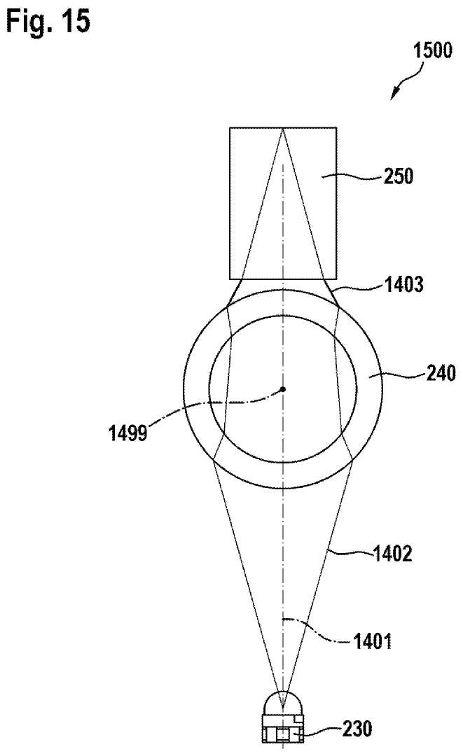

FIG. 15 shows the infrared emitter 230, the tube level 240, and the light guide 250, and illustrates a situation 1500, in which the air bubble 1115 of FIG. 11, FIG. 12, and FIG. 14 is absent or arranged outside of an associated measurement range. Here, the tube level 240 is illustratively designed along path 1401 substantially perpendicular to the level axis 1499 associated with the rotary level 240 as a converging lens. Preferably, the rotary level 240 is configured as a cylindrical converging lens. Furthermore, the light guide 250 is preferably configured as a prism, which elongates an optical distance between the infrared emitter 230 and the photodiodes 262, 264 in FIG. 11, FIG. 12, and FIG. 14. The distances are preferably chosen such that the image plane of the infrared emitter 230 falls within the photosensitive areas 1421, 1422 of the photodiodes 262, 264 in FIG. 11, FIG. 12, and FIG. 14.

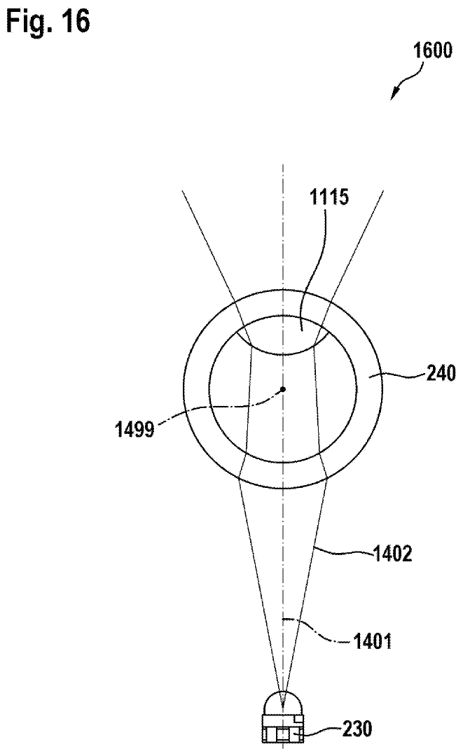

FIG. 16 shows the infrared emitter 230 and the tube level 240 and illustrates a situation 1600, in which the air bubble 1115 of FIG. 11, FIG. 12, and FIG. 14 is present or is arranged within an associated measurement range due to a comparably small inclination of the inclination sensor module housing 210. Preferably, in the presence of the air bubble 1115, the light beam 1402 generated by the infrared emitter 230 is dispersed, resulting in shadowing of the photodiodes 262, 264 in FIG. 11, FIG. 12, and FIG. 14.

FIG. 17 shows the inclination sensor 184 of FIG. 1 to FIG. 8, FIG. 10, and FIG. 11. In a method for manufacturing the inclination sensor 184, first the tube level 240 is arranged within the inclination sensor module housing 210 and/or in the interior receptacle 309. Preferably, the tube level 240 is arranged on the support element 433, 431 in FIG. 4, or on the associated planar support surfaces 432, 434 in FIG. 4. Subsequently, biasing of the tube level 240 is accomplished by way of the spring-loaded element 399. The spring-loaded element 399 is inserted into the interior receptacle 309 of the inclination sensor module housing 210 through the recess 570 in FIG. 5 and biased in the opposite recess 650 of the side surface 202, shown on the left in the illustration. The spring-loaded element 399 preferably partially abuts the outer circumference 398 of the tube level. According to one embodiment, after pre-securing the tube level 240, the inclination sensor module housing 210 is closed. Preferably, the light guide 250 is arranged in the inclination sensor module housing 210. Alternatively or optionally, the infrared shield 220 and/or the circuit board 270 are arranged on the inclination sensor module housing 210.

Subsequently, a measurement error is compensated by displacing the tube level 240 along its longitudinal extension 401 in FIG. 4 through the lateral recess 411, 412 in FIG. 4 on the inclination sensor module housing 210. The measurement error, i.e., the incorrect arrangement of the tube level 240 to the light guide 250, or the photodiodes 262, 264 in FIG. 2, FIG. 5, FIG. 6, FIG. 11, FIG. 12 and FIG. 14, is preferably determined by a reversal measurement method. The adhesive 1810 is then applied through the recess 610 arranged in the inclination sensor module housing 210 at the first side surface 202 for securing the tube level 240. The adhesive 1810 is arranged in the interior receptacle 309 of the inclination sensor module housing 210 between the side surface 202 and the tube level 240. Finally, the adhesive 1810 is cured by way of UV light.

Curing of the adhesive 1810 is preferably accomplished by the light guide 250 arranged on the top side 303 of the inclination sensor module housing 210 via a UV lamp. Alternatively, the curing of the adhesive 1810 is carried out through the lateral recess arranged on the side surface 201, shown on the right in the illustration, or the UV light introduction area 520 in FIG. 5 via a UV lamp. Finally, the spring-loaded element 399 is preferably pulled out of the inclination sensor module housing 210. Preferably, the spring-loaded element 399 is merely for biasing the tube level 240 and does not remain in the inclination sensor module housing 210.

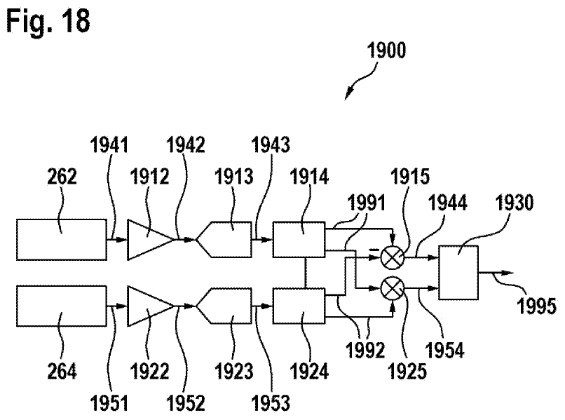

FIG. 18 illustrates a control device 1900 configured to determine an inclination 1995 of the laser unit 130 of FIG. 1 using the inclination sensor 184 of FIG. 1 to FIG. 8, FIG. 10, FIG. 11, and FIG. 17. Preferably, the at least one photodiode 262, 264 is configured to generate a photocurrent 1941, 1951 depending on the particular inclination 1995. Preferably, the control device 1900 is configured to determine the inclination 1995 of the laser unit 130 by separately measuring the photocurrent 1941, 1951. The inclination sensor 184 preferably comprises two photodiodes 262, 264, each generating a photocurrent 1941, 1951 associated with the inclination 1995.

The control device 1900 preferably comprises a transimpedance converter 1912, 1922 associated with the at least one photodiode 262, 264. The at least one transimpedance converter 1912, 1922 is preferably configured to convert a photocurrent 1941, 1951 determined by the at least one photodiode 262, 264 into a proportional voltage 1942, 1952. Furthermore, preferably, the control device 1900 comprises at least one analog-to-digital converter 1913, 1923 associated with the at least one photodiode 262, 264. The at least one analog-to-digital converter 1913, 1923 is preferably configured to convert the each of the photocurrents 1941, 1951, which have an analog format and are converted by the at least one transimpedance converter 1912, 1922 into a proportional voltage 1942, 1952, into a digital format or into a digital voltage 1943, 1953. Moreover, preferably, the control device 1900 comprises at least one low-pass filter 1914, 1924 associated with the at least one photodiode 262, 264. The at least one low-pass filter 1914, 1924 is preferably configured to suppress or filter out the noise of the digitized voltage 1943, 1953 and thus convert it into a filtered voltage 1991, 1992. Finally, preferably, the control device 1900 determines the inclination 1995 as a quotient of a signal difference 1944 and a signal sum 1954 of the filtered voltages 1991, 1992. The signal difference 1944 is preferably generated at a switching element 1915 and the signal sum 1954 at a switching element 1925. The inclination 1995, or the quotient of the signal difference 1944 and the signal sum 1954, is preferably determined in a switching element 1930.

Preferably, two photodiodes 262, 264 are provided, wherein, in the illustration, the photodiode 262 generates the photocurrent 1941, which is converted by the transimpedance converter 1912 into a proportional voltage 1942, which is subsequently converted by the analog-to-digital converter 1913 into a digitized voltage 1943, which is converted by way of the low-pass filter 1914 into the filtered voltage 1991. Furthermore, in the illustration, the photodiode 264 generates the photocurrent 1951, which is converted by the transimpedance converter 1922 into a proportional voltage 1952, which is subsequently converted by the analog-to-digital converter 1923 into a digitized voltage 1953, which is converted by way of the low-pass filter 1924 into the filtered voltage 1992.

The control device 1900 is preferably associated with the inclination sensor 184. According to one embodiment, control device 1900 is arranged on the circuit board 270 of the inclination sensor 184. Alternatively, the control device 1900 may be associated with the electronics unit 190 of the rotary laser 100 of FIG. 1.

In a method for controlling the rotary laser 100 by way of the control device 1900, the infrared light generated by the infrared emitter 230 is preferably first measured by the at least one photodiode 262, 264. Subsequently, the photocurrent 1941, 1951 generated by the at least one photodiode 262, 264 is preferably converted into the proportional voltage 1942, 1952. By way of the at least one analog-to-digital converter 1913, 1923, the proportional voltage 1942, 1952 is preferably converted into the digitized voltage 1943, 1953. Subsequently, the digitized voltage 1943, 1953 is preferably filtered by way of the at least one low-pass filter 1914, 1924 into the filtered voltage 1991, 1992. Finally, preferably, the inclination 1995 is determined by dividing the signal difference 1944 of the filtered voltage 1991, 1992 and the signal sum 1954 of the filtered voltage 1991, 1992.

The inclination 1995 is preferably determined independently of the intensity of the infrared emitter 230. Alternatively or optionally, the inclination 1995 is determined independently of the intensity of the at least one photodiode 262, 264.

An advantage of the method is that a larger linear measurement range of the tube level 240 enables subsequent software calibration of an associated operating point based on the actual orientation of the tube level 240 relative to the axis of the infrared emitter 230. Thus, the requirements for precise mechanical alignment and calibration of the tube level 240 and of the axis of the infrared emitter 230 as components of the rotary laser 100 can be improved.

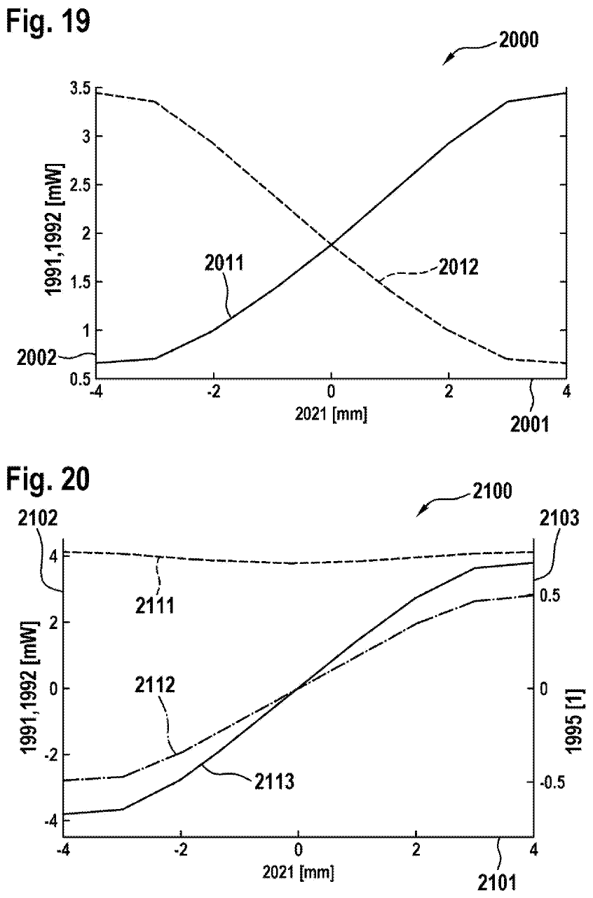

FIG. 19 shows a graph 2000 with an abscissa axis 2001 representing a bubble position 2021 of the air bubble 1115 of the tube level 240 in mm and with an ordinate axis 2002 representing the filtered voltage 1991, 1992 in mW, as determined by the control device 1900 of FIG. 18. A curve 2011 visualizes the filtered voltage 1991 of the photodiode 262 and a curve 2012 visualizes the filtered voltage 1992 of the photodiode 264. The individual photocurrents and filtered voltages 1991, 1992 behave inversely to one another as a function of the bubble position 2021 and/or the inclination 1995 of the inclination sensor 184.

FIG. 20 shows a graph 2100 with an abscissa axis 2101 representing a bubble position 2021 of the air bubble 1115 of the tube level 240 in mm and an ordinate axis 2102, shown on the left in the illustration, representing the filtered voltage 1991, 1992 in mW determined by control device 1900 of FIG. 18, and an ordinate axis 2103, shown on the right in the illustration, representing the inclination 1995. A curve 2111 illustrates the signal sum 1954 of the filtered voltages 1991, 1992, and a curve 2112 illustrates the signal difference 1944 of the filtered voltages 1991, 1992. A curve 2113 illustrates the quotient of the signal sum 1954 and the signal difference 1944 or the inclination 1995 determined by the control device 1900. Around the operating point, where the bubble position 2021 is at 0 mm, the signal sum 1954 is approximately constant and the signal difference 1944 as well as the determined inclination 1995 are approximately proportional to the inclination 1995.

What is claimed is:

1. A rotary laser, comprising:
a housing;
a laser unit arranged in the housing; and
a leveling unit having at least one inclination sensor configured to determine an orientation of the laser unit relative to a reference surface,
wherein the at least one inclination sensor has an inclination sensor module housing arranged in the housing, and
wherein the inclination sensor module housing has at least one planar support surface on at least one side surface for precise planar alignment of the inclination sensor module housing in the housing.

2. The rotary laser according to claim 1, wherein:
the housing has a base plate with at least one planar support area, and
the at least one planar support area is associated with the at least one planar support surface.

3. The rotary laser according to claim 1, wherein the at least one planar support surface is divided into at least two spaced-apart sub-surfaces.

4. The rotary laser according to claim 3, wherein:
the at least two spaced apart sub-surfaces are arranged in a common plane, and
the common plane is arranged parallel to the associated side surface of the inclination sensor module housing.

5. The rotary laser according to claim 3, wherein the at least one planar support surface has three sub-surfaces arranged in a triangle.

6. The rotary laser according to claim 3, wherein:
the housing has a base plate with at least one planar support area,
the at least one planar support area is associated with the at least one planar support surface,
the inclination sensor module housing has at least one support surface on a first side surface, and
the inclination sensor module housing is configured to be arranged on the base plate for a first alignment by way of the at least one support surface on the first side surface.

7. The rotary laser according to claim 6, wherein:
the inclination sensor module housing further has an at least one additional support surface on a second side surface, and
the inclination sensor module housing is configured to be arranged on the base plate for a second alignment by way of the at least one additional support surface on the second side surface.

8. The rotary laser according to claim 6, wherein the first side surface is arranged perpendicular to the second side surface.

9. The rotary laser according to claim 6, wherein:
the housing has a base plate with at least one planar support area,
the at least one planar support area is associated with the at least one planar support surface, and
the base plate has (i) a first section configured to arrange the inclination sensor module housing in the first orientation, and (ii) a second section aligned perpendicular to the first section and configured to arrange the inclination sensor module housing in the second orientation.

10. The rotary laser according to claim 1, wherein:
a tube level is arranged in an interior receptacle of the inclination sensor module housing, and
the tube level is fixed in the interior receptacle of the inclination sensor module housing by an adhesive bond.

11. The rotary laser according to claim 10, wherein the inclination sensor module housing is configured such that an adhesive for forming the adhesive bond is introducible into the interior receptacle through a recess from outside the inclination sensor module housing.

12. The rotary laser according to claim 11, wherein the recess is arranged on a side surface arranged perpendicular to the at least one support surface.

13. A method for manufacturing the inclination sensor of the leveling unit of the rotary laser of claim 1, the method comprising:
arranging the tube level within the inclination sensor module housing;
biasing the tube level by way of a spring-loaded element;
compensating for a measurement error by displacing the tube level along its longitudinal extension through at least one lateral recess arranged on the inclination sensor module housing;
applying adhesive through a recess to secure the tube level; and
curing the adhesive by way of UV light.

14. The method according to claim 13, wherein the inclination sensor module housing is closed after the tube level has been pre-fixed.

15. The method according to claim 13, wherein:
after the adhesive has been applied, the adhesive is cured by way of UV light, and
the UV light is applied through a lateral UV light introduction area on a fourth side surface opposite the third side surface of the inclination sensor module housing or through a UV light introduction area arranged on a top side of the inclination sensor module housing into the inclination sensor module housing.
